(19) United States
(12) Patent Application Publication
(10) Pub. No.: US 2012/0221944 A1
(43) Pub. Date: Aug. 30, 2012

(54) SYSTEM FOR DIGITAL AND REMOTE DOCUMENT REVISION AND EXECUTION WITH DOCUMENT ESCROW

(76) Inventors: Richard H. Bloomfield, Alpine, UT (US); Jonathan K. Black, Alpine, UT (US); Ofir Ramirez-Rios, Alpine, UT (US)

(21) Appl. No.: 13/406,426

(22) Filed: Feb. 27, 2012

Related U.S. Application Data
(60) Provisional application No. 61/447,602, filed on Feb. 28, 2011.

(51) Int. Cl. G06F 17/00; G06F 15/16

(52) U.S. Cl. 715/255

(57) ABSTRACT

A system electronically prepares, escrows and stores in a server cloud a digital representation of a paper document, copies of which may be modified by wet ink pen marks in different geographic locations. The wet ink pen marks are digitized and stored with the escrowed document, through use of digital devices such as digital wet ink pens. As the digitized wet ink pen marks are created, parties may view the escrowed document and digitized wet ink pen marks in near real-time in different geographic locations. After the parties finish placing wet ink marks, such as signatures on a closing document, the document may be released from escrow for printing and/or storage.

### RELATED APPLICATIONS

The present application claims the benefit of U.S. Provisional Application Ser. No. 61/447,602, filed Feb. 28, 2011, which is expressly incorporated herein by reference.

### THE FIELD OF THE INVENTION

The present invention relates to document execution. More specifically, the present invention relates to a system for digital and remote document revision and execution with document escrow.

### BACKGROUND

Many transactions may require a closing. A closing may include a time and place where all parties come together to execute documents that bind the parties. Closings often require the signatures and/or initials of multiple people on multiple places in the documents. For example, to ensure that each party has read and understands the terms of a contract, the parties may be required to initial each page and to sign the end of the document, thereby verifying the completeness of the contract.

In many closings, the participants involved in the transaction reside in multiple locations, making it difficult to secure all needed signatures at the same time. In some closings, documents may be sent via mail or secured carrier to all closing participants individually. Unfortunately, this leaves at least one party hoping that the documents are executed properly and returned timely and without incident. In some rare cases, one party will execute the document and proceed to act with the mistaken belief that the other party has executed the document. The other party may unintentionally or intentionally delay signing the document to gain some sort of procedural advantage.

The lack of all of the parties signing the document also complicates the ability to make revisions. For example, if a party objects to a certain provision of a contract, all of the parties may need to line through the provision, make any necessary modifications and then initial by the modifications. As copies are passed around, no two copies look exactly the same and subsequently a signing party may forget to initial the change, or the change may not be identical between the various drafts.

In other closings, all closing participants may be brought to one location to execute the closing in person. Such is expensive and slows down the process due to travel schedules and the like. In yet other closings, multiple document sets are used, such as agreements signed in parts, such that each party may receive multiple documents. Each document set may only contain some of the signatures as they are passed from party to party.

Regardless of location, the closing process may require that each participant in the closing sign in predetermined locations, including an initial for each page of a lengthy closing document, which may exceed 300 pages. Each signature and/or each initial on each page of the document for all participants in a closing is often executed or signed manually by a representative of each party in a closing.

After the closing is considered complete, a representative of each party in the closing may take the signed documents and scan them into large electronic picture files for distribution to all parties via the Internet, secure server, CD's, or, if small enough, via email. Each party may also then need to save these electronic documents into an electronic storage facility of some kind, as many legal documents (estate planning documents for example) may be required to be saved until the death of the closing participant. The size of these picture files becomes problematic and costly for larger companies that deal with large quantities of signed legal documents. If multiple document sets are used (such as agreements signed in parts), a copy of all documents must be kept, which multiplies the document archiving problem.

Additionally, large companies may lose track of their electronic documents (or the content within a document) and need a simple and easy way to find them. Unfortunately, one of the significant limitations of scanned picture files is that they may not be searchable. Overall, the manual processes and outdated technologies used in legal closings today may be costly, time consuming and fraught with human error.

### SUMMARY OF THE INVENTION

It is an object of the present invention to provide an improved system for digital and remote document revision and execution.

The above and other objects of the invention are realized in an improved system for digital and remote document revision and execution wherein a document may be worked on simultaneously from multiple locations.

According to one aspect of the invention, a document being revised and/or executed may be held in escrow until all of the parties are satisfied that the document has been completed.

According to one aspect of the invention, a document may be displayed on a computer screen which allows the parties to view and sign an agreement in real-time or near real-time. Each signature may be recorded from a separate geographical location, but displayed to all groups involved whatever their geographical location. The real-time display of signatures may allay fears of either party about signing an agreement before the other party, while enabling signatures from distant locations in real-time.

According to another aspect of the invention, each interaction with the document may be recorded. The interactions may include information such as time stamps, date stamps, location stamps, “pen” number, order of the interactions and other data so that the parties may be assured of the authenticity of the interactions.

According to another aspect of the invention, the system may check a document for signatures in specified locations within the document. If not all locations contain a signature, the system may display a warning or error, alerting the parties to missing information. The warnings may prevent incomplete documents, missing pages and potential litigation.

According to another aspect of the invention, the system may escrow a document such that it may not be released to the parties until each party approves of it. Once approved, the document may include security features such that both parties may recognize the master approved document as complete and fully executed.

According to another aspect of the invention, each interaction with the document may be stored in the electronic file with the original text. By storing each interaction rather than converting entire pages to images, the file size may dramatically decrease. Another advantage is that the electronic file may retain its text searching capabilities.

In accordance with another aspect of the invention, each location of a closing may have a paper or digital copy of the document. As any change is made to the document, the changes appear on the master document which can be viewed by all parties. Thus, if any provision is marked out, added to, initialed, etc., using an input device on the copy of the document at one location, the same change is made on the master document, thereby ensuring that all parties get exact modifications to the document.

These and other aspects of the present invention are realized in a system for digital and remote document revision and execution with document escrow as shown and described in the following figures and related description.

### BRIEF DESCRIPTION OF THE DRAWINGS

Various embodiments of the present invention are shown and described in reference to the numbered drawings wherein:

FIG. 1 shows an overview diagram of a digital and remote document revision and execution system with document escrow;

FIG. 2 shows a hardware diagram of a digital and remote document revision and execution system with document escrow;

FIG. 3 shows a hardware diagram of a digital and remote document revision and execution system with document escrow performed with tablets;

FIG. 4 shows a flowchart of options and processes available in a digital and remote document revision and execution system with document escrow;

FIG. 5 shows a flowchart of a preparation process with local software in a digital and remote document revision and execution system with document escrow;

FIG. 6 shows a flowchart of an execution process with local software in a digital and remote document revision and execution system with document escrow;

FIG. 7 shows a user process flow diagram of a digital and remote document revision and execution system with document escrow;

FIG. 8 shows a software interaction diagram of a server, user and pen in a digital and remote document revision and execution system with document escrow; and

FIG. 9 shows a software configuration of a server in a digital and remote document revision and execution system with document escrow.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

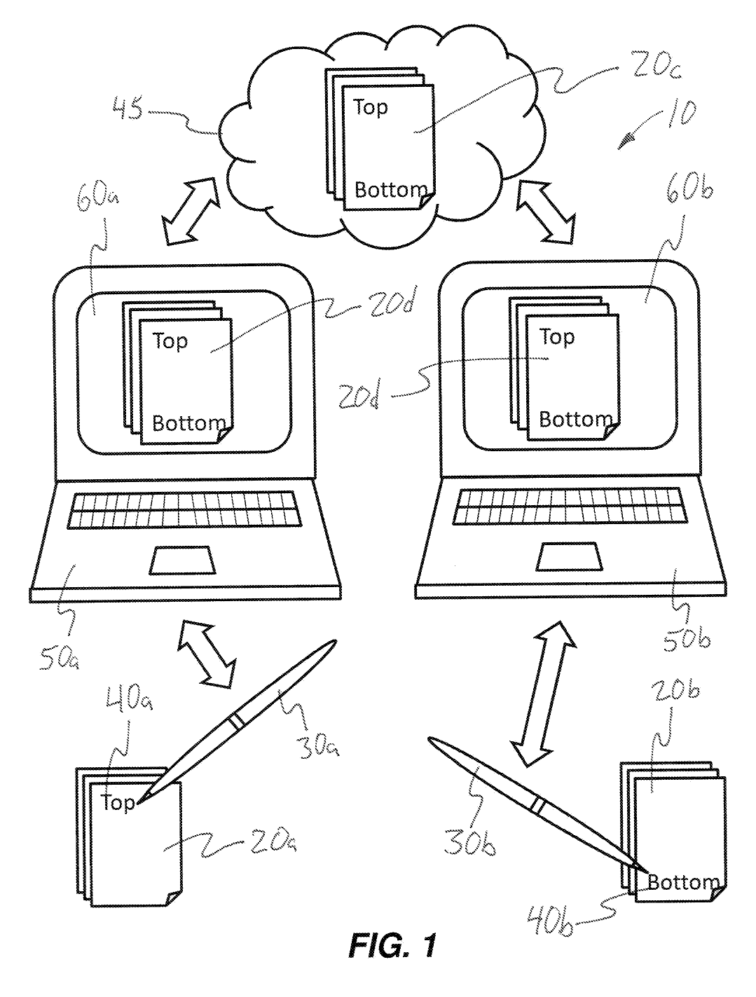

FIGS. 1 to 3 show hardware interactions in the digital document revision and execution system 10 and may provide for document escrow. In one application, the digital document revision system can be used for a closing or other execution and may include only one or two parties. For example the digital document revision and execution system 10 may be used for executing a will or trust, a contract, a real estate closing, etc.,

A master document 20c may be housed on a server, in a cloud 45, etc., and shown on a display 60a of a computer 50a or some other device. A printed version 20a of the master document may be provided to the person participating in the execution thereof. The person is able to make revisions to the printed version 20a of the document with a digital input device 30, such as a digital pen. A digital pen allows the person to sign the document and to make any other notes or marks, such as initialing each page of the document, lining out unwanted provisions, etc. Each marking on the page of the printed version 20a is digitized and transmitted to and marked on or stored with the master document 20c in substantially real time. The technology for the digital pen recognizing the location of the change relative to the master document 20c is marketed under the trademark NETPAGE by Silverbrook Research Pty Ltd, 3 Montague Street, Balmain NSW 2041, Australia. Utilizing this technology in conjunction with a master document for execution provides an accurate copy of any revisions to the printed version 20a of the master document 20c. The person executing the paper document 20a may retain the “wet ink” version of the document upon completion, as the master document 20c on the server, etc., contains all of the changes. This may be saved by the law firm, real estate title company, etc.

In a situation such as the execution of a trust, this enables a copy of the master document 20c to be saved immediately upon execution and avoids the need for scanning documents which may be hundreds of pages long. Additionally, the master document may have fields to ensure that each place for initialing or requiring the input of information has been completed so that the document is not scanned within omitted information. This significantly reduces the time to finish the execution of a large document, ensures that the document is complete copy and that a copy of the entire executed document is available. It also allows the client to promptly leave with the hard copy “wet ink” version of the document. This will save substantial time, space and effort for law firms, real estate offices and the like.

A variant of this system may be used for executing documents where the parties are remote from one another—or simply to ensure proper execution of large documents. A digital and remote document revision and execution system 10 with document escrow may enable parties to sign a document at the same time in different places without fear that the document is released without their permission, thereby preventing one party from obtaining signatures of the other side and then delaying execution for some potential strategic reason. With document escrow, the document may only be released upon approval of all the parties, allowing for a voluntary agreement. When released, the document includes the signatures and edits as performed by the parties.

The system may also include computerized checks for signatures at specific locations within the document, ensuring a fully executed document, including verification of key terms. Each signature or edit may be tied to a specific pen or device at a specific location at a specific time, and thus ensure the integrity of the document and to verify the location at which each signature was entered.

The master document may also be text-searchable in a reduced file size form, in fidelity with the original document printed. This allows for much easier archiving of large documents and ensures that everyone has a copy of the same document The system may be useful in execution of agreements and/or edits in many fields, including real estate, mortgages, contracts, business sales, legal settlements, large purchases, and estate plans. In some embodiments where wet-ink signatures are digitized, the original wet-ink signature documents may be retained for transactions that require it.

Reference to a signal-bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Turning now to FIG. 1, an overview diagram of a digital and remote document revision and execution system 10 is shown. It is currently known to generate a document with optical markings that can be read by a digital pen so as to record the actions of the digital pen, such as making marks on the document such as a signature. An example of such a system is the Netpage™ system marketed by Silverbrook Research Pty Ltd, 3 Montague Street, Balmain NSW 2041, Australia.

The present invention utilizes such technology for use in environments where multiple people are working on a single document. Thus, as shown in FIG. 1, a single document 20a, 20b, 20c may be revised by one or more parties with digital pens 30a, 30b that write ink changes 40a, 40b on paper documents 20a, 20b. Each ink change 40a, 40b made to the paper documents 20a, 20b is digitized and synchronized with a master digital document 20c stored on a server or server cloud 45. Representations 20d of the master document may be shown in real-time or near real-time on the displays 60a, 60b of computers 50a, 50b. As ink changes 40a, 40b are made on the document 20a, 20b, the change is recorded on the master digital document 20c and displayed on the representations 20d on the displays 60a, 60b of the computers 50a, 50b. It should be understood that ink changes 40a, 40b should be recognized as signatures or edits recorded and stored with an original document file. Thus an ink change 40a, 40b may include lining out text, inserting text, initials, signatures or other edits; these edits may be converted and stored in or with the original document file. The ink changes 40a, 40b may be made by technologies including digital pens, tablet computers, touch screen computers, mouse and display or other method of input that may allow a user to place edits on an original document.

In a simple version, the system allows two people to work on a document together and each have access to the fully executed document. For example, two attorneys may be working on a stipulation to be filed with the court. In conventional electronic filing, the document is either signed by both and then scanned, or one attorney electronically signs for both attorneys with a statement that the electronic signature for the other attorney has been consented to. In accordance with the present invention, the two attorneys could finalize the agreement, each could sign the agreement and save a PDF for their own records, and a PDF of the executed agreement could be electronically filed with the court.

In other environments, however, more security is needed. Each party may not want the other to have a copy of the agreement with his or her signature without having that party first sign the agreement. Thus, the master document 20c, may be securely stored and escrowed until approved by all parties. In one configuration, this approval may be made by one party, such as a mediator. In another configuration, this approval may be required by each of the parties to the agreement. This could be accomplished, for example, by each party having a code which must be entered before the agreement is released from escrow. Until valid approval is received, the document may be displayed on computers 50a, 50b, but not finalized or released. This may mean that neither party may copy or print the partially executed document, or that the document may be printed or copied along with a designation that it is only a draft and not the final agreement. Once valid approval is given, the master document 20c may be finalized, released from escrow and downloaded and/or printed by the parties.

The master document may be created in a standard program, and uploaded to the server cloud 45. The server cloud 45 may store the document in a different format than received, including PDF, images or even a set of files. In one embodiment, the document is converted to a Portable Document Format (PDF, including the ISO 32000 standard) file format by a user. The PDF file may be uploaded to the server cloud 45, where it is received awaiting escrow. In other cases, the server may accept files and convert them on the server to a desired format, such as DOC, XLS, PPT, ODF, DOCX, XLSX, PPTX, JPG, GIF, PNG, PDF/A, PDF/X, PDF or other file formats. After upload and before escrow, the server cloud 45 may also allow document manipulation, such as combining documents or pages, adding documents or pages, reordering documents or pages, and/or removing documents or pages.

Similarly, the document may be sent to the computers 50a, 50b in a viewable only format. This may be done through secure or insecure methods and channels, depending on the needs. In one embodiment, a PDF viewer is sent updates as ink changes 40a, 40b are made. In another embodiment, an image viewer is sent images created from the master document 20c with ink changes 40a, 40b. The server cloud 45 may send a copy of the master document file directly over a secure connection or convert the master document file to a new file before sending. The file may be received by a custom program on the computers 50a, 50b, through standard software already available (such as a browser) or on-demand software delivery (such as Java applets, ActiveX controls, or javascript programs).

It should be recognized that while laptop computers have been shown for convenience, a computer should be broadly read to encompass a device with a display and the ability to process information. This may include PC's, smartphones, iPads™, tablets, netbooks, laptops, mobile devices and other computing technologies.

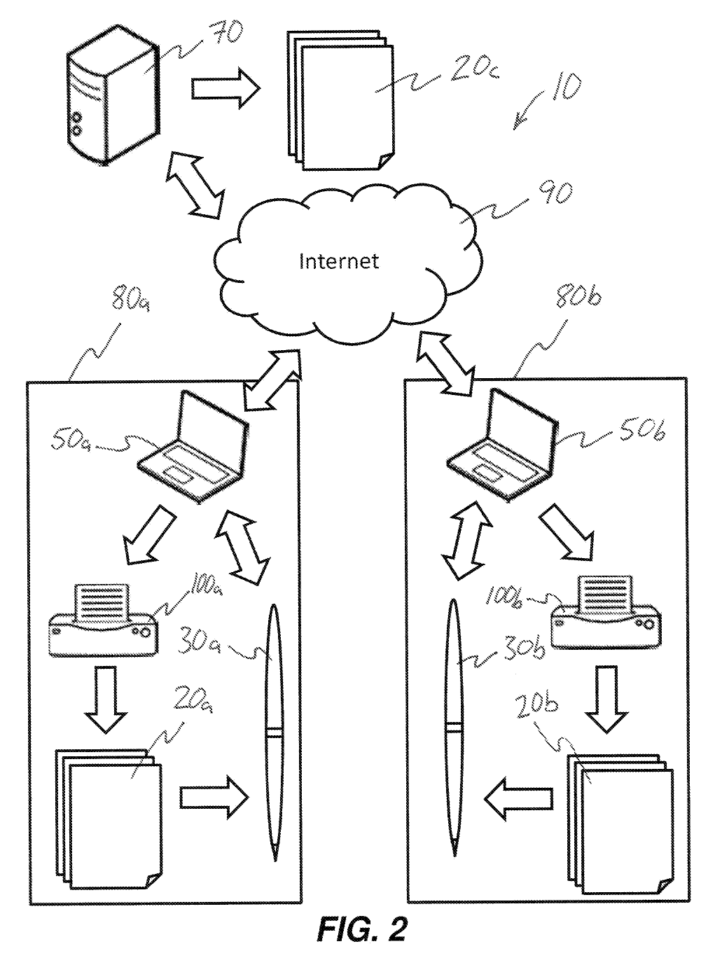

Turning now to FIG. 2, a hardware diagram of a digital and remote document revision and execution system 10 with document escrow is shown. A document server 70 may store a master document 20c. The document server 70 may communicate with computers 50a, 50b at locations 80a, 80b over a network, such as the internet 90. A copy of the master document may be printed on paper documents 20a, 20b by printers 100a, 100b. Digital pens 30a, 30b may record ink changes 40a, 40b. The digital pens 30a, 30b may synchronize the ink changes 40a, 40b with the master document 20c.

The digital pens 30a, 30b may recognize the document through different technologies. In one embodiment, the digital pens 30a, 30b may recognize the paper through patterns printed on the paper. The patterns may not only identify a specific document, but also the location of the pen within that document. An example of such technology is a Netpage™ Pen and Netpage™ printed document.

The digital pens 30a, 30b may synchronize in multiple ways. In the embodiment shown, the digital pens 30a, 30b may communicate with a computer 50a, 50b in the local location 80a, 80b. The computer 50a, 50b may relay the digital pens 30a, 30b communication with the document server 70 through the internet 90. The document server 70 may then update computers 50a, 50b with new ink changes 40a, 40b. Each action taken by the digital pens may be recorded for verification purposes. Thus, for example, a signature of a party may appear on the master digital document along with a time-stamp and code which shows which digital pen 30a or 30b made that signature.

It should be recognized that number of locations and number of pens may be altered. For example, in some situations, the parties may meet face-to-face in a conference room. Therefore only one or two pens may be needed along with a single computer displaying the master document and/or relaying information to the document server. Similarly, there may be more than two locations required, e.g. four pens may be used in three different geographic locations, with two pens sharing one location. Thus, the locations and number of devices to record ink changes may be altered to suit the needs of the parties.

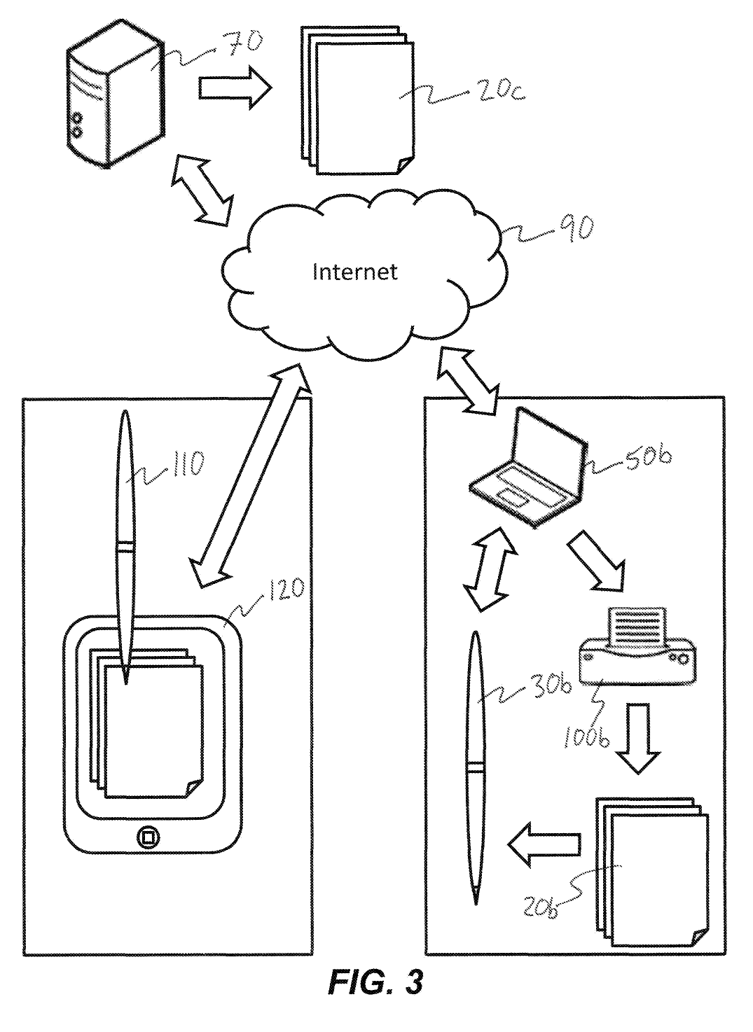

Turning now to FIG. 3, a hardware diagram of a digital and remote document revision and execution system with document escrow performed with tablets is shown. In another embodiment, a stylus 110 may be used with a tablet 120, such as an iPad™ such that the tablet 120 forms a substitute for the paper documents and/or computer 50a described in FIG. 2. The tablet may record the ink changes 40a, 40b (see FIG. 1) virtually, while receiving updates from the server 70 created by other tablets or digital pens 30b.

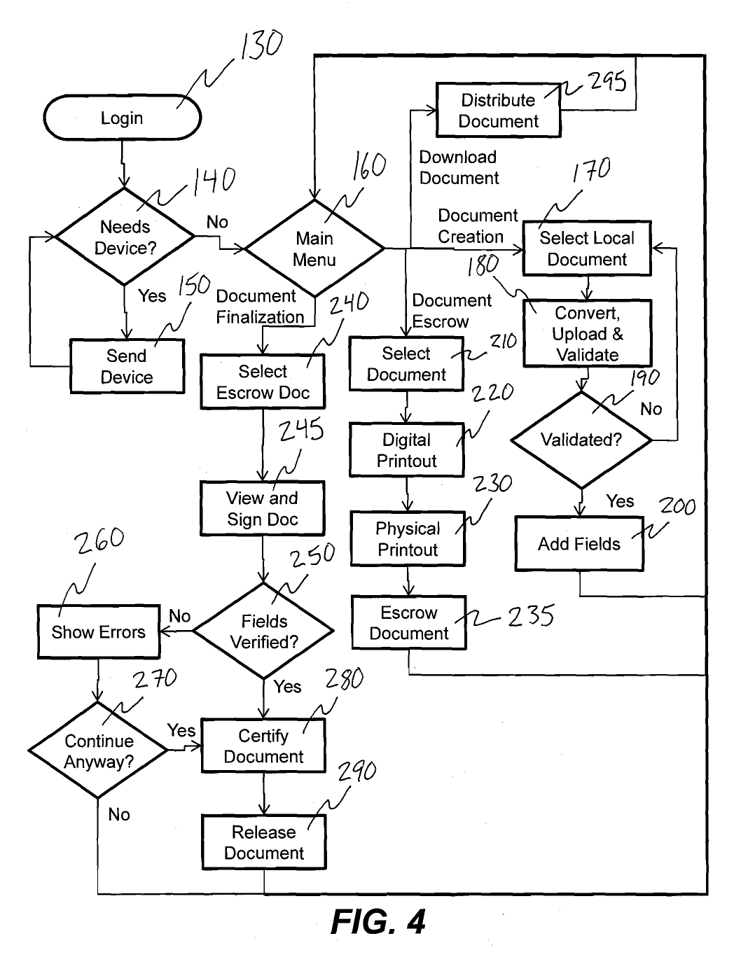

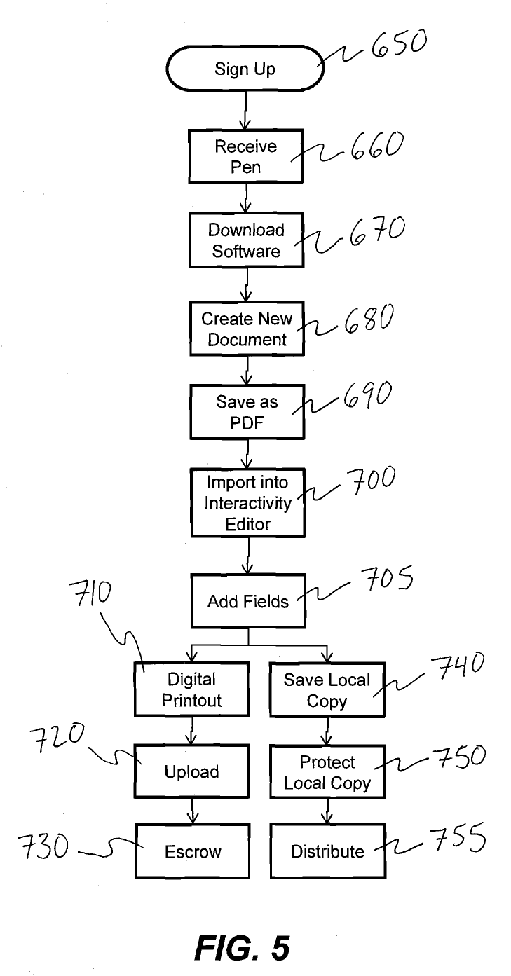

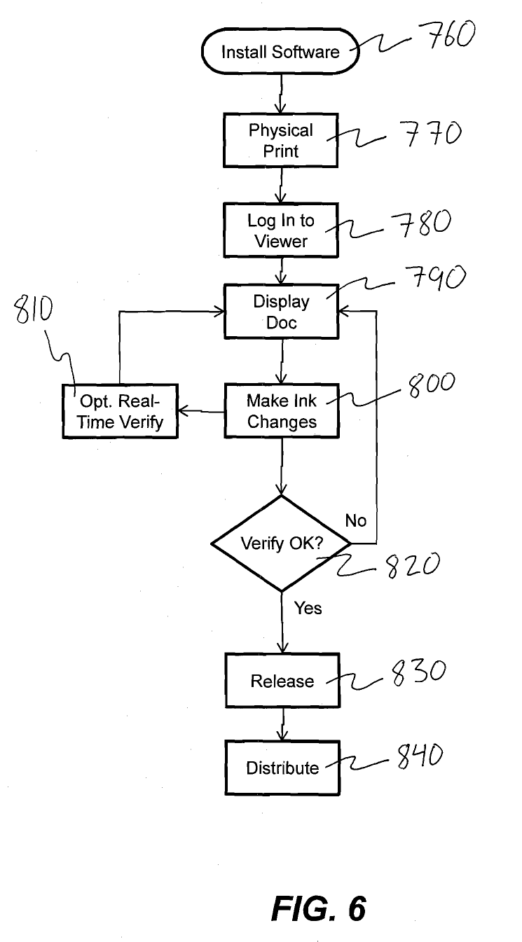

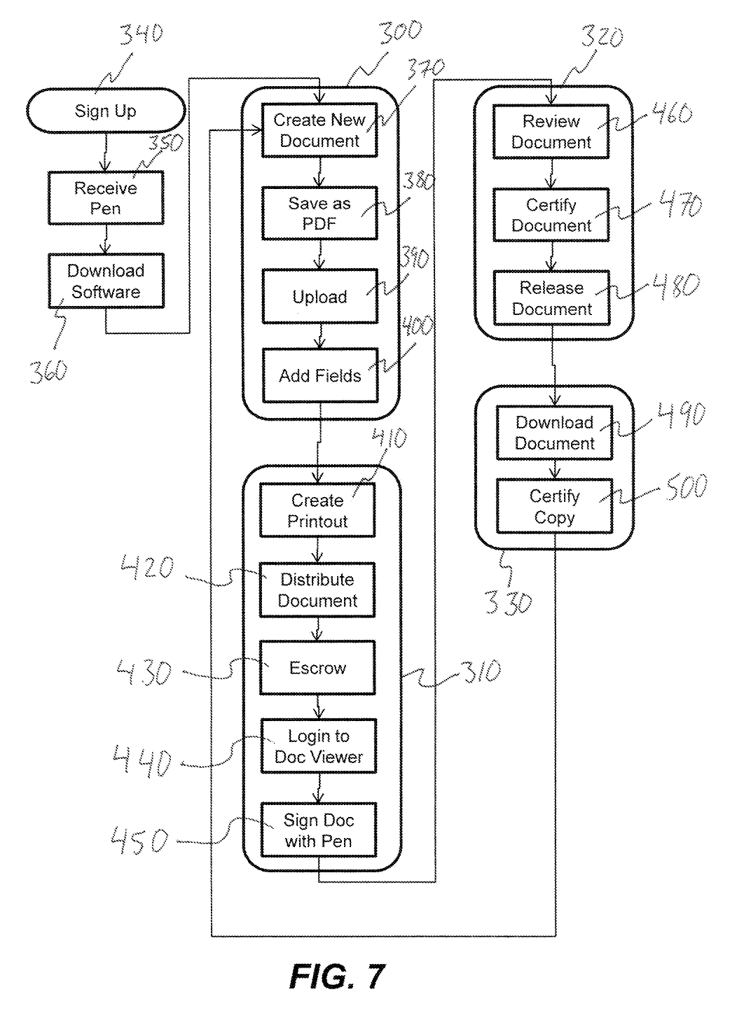

FIGS. 4 to 7 show flowcharts of interactions with and available through the digital and remote document revision and execution system with document escrow. In FIGS. 4 and 7, the process may be seen as a cloud based software as a service. In FIGS. 5 and 6, the process shown may include client-side software. The processes may be divided up into four stages: Document Creation, Document Escrow, Document Finalization and Download Document. The document creation stage may involve taking a normal document and preparing it to become a master document by converting the document to a standard file type and adding fields for ink changes. The document escrow stage may involve protecting a master document and activating the ability to make ink changes. The document finalization stage may involve making ink changes, initials or signatures, verification of ink changes, fields and certification by parties. The download document phase may include certification of master copies, and document retention.

The sequences shown in FIGS. 4 to 7 may be stored on a signal bearing medium, such that a computer may perform the processes described, including Document Creation, Document Escrow, Document Finalization and Download Document.

The service may be set-up for different user types. In one embodiment, the user may be a mediator or neutral party. The mediating party may then be the system administrator that uploads, escrows, and finalizes documents for the parties. The mediating party may also be responsible for receiving the approval from the parties and then approving ink changes to the master document. In another embodiment, the parties themselves may be the users. One party may link to one or more parties' accounts or give access to a master document to one or more parties. Once granted and accepted, the system may require agreement between parties to move to the next step or stage, such as from escrow to finalize.

It should be recognized that many steps in the diagram may be done in parallel, out of order, expanded into multiple steps or collapsed into one step. The flowcharts and steps are meant as exemplary embodiments of the processes available.

Turning now to FIG. 4, a flowchart of options and processes available in a digital and remote document revision and execution system with document escrow is shown. Once a user logs into the service 130, the service may determine if the user needs a device 140, such as a digital pen 30a, 30b or tablet 120. If so, one or more devices may be sent 150. If not, the user may be presented with a main menu 160 in which they may choose to create a document, escrow a document, finalize a document or download a document.

The Document Creation process may convert a normal document to a master document and assign fields. Once the user selects Document Creation, the user may be requested to select a local document to upload 170. The document may be sent to the server and validated 180. The validation may include checking for file corruption, spelling, and consistency in word use and/or length. If the validation fails 190, the user may be requested to upload a new document. If validation passes 190, a user may add fields to the document 200. A field is an area of the document where an ink change may be expected.

The document fields may added automatically or manually. In one embodiment, the system detects document clues, such as blank underlining or boxes, where information or signatures are normally placed, and suggests fields be added relative to the underline. In another embodiment, the system allows a user to define fields by using a rectangle or polygon. The system may also use a combination of automatic and manual field definitions.

The fields are useful for a double checking mechanism. In document execution, it may be important to have each page initialed on a defined line and signatures at the end of the document. A computer, such as the server or server cloud, may perform this double checking by determining if an ink change is located within a field. Depending on settings and configuration, the fields may be optional or required. Optional fields may be displayed as document warnings during verification; required fields may be displayed as errors. The document may also be configured in a “lock down” mode, where the system would only accept ink changes within a field rather than anywhere within the document to thereby prevent a party from editing the document.

The Document Escrow process may take a validated document, protect it and start tracking ink changes. Once complete with the Document Creation process, a document may be available for the Document Escrow process. The user may select one of the prepared documents 210 and review it if desired. The document may then have a digital printout performed 220, where the base document becomes configured for receiving ink changes. In one embodiment, the digital printout may include placing markings on the paper for recognition by digital pens. The document may then be printed out physically 230 and then escrowed 235, and as such, become unavailable for further download or revision until the closing is complete and the parties agree. Document protection mechanisms may be then employed on the files used for the physical printout, such that further printing may be restricted. This may include limiting the number of printouts or causing the file opening or printing permission to expire.

In one embodiment, the ink changes are overlaid on the master document. The master document may be a file type that allows layering of text and images, such as PDF. The bottom layer may be the master document text in searchable PDF form. Ink changes may be added to the PDF by placing a layer over the area affected by the ink changes. Thus, in the case of a signature, a small single color image block may be added over the signature area. This aids in the reduction of file size because single color overlays are added to the original document.

The Document Finalization process may take an escrowed document, display it for viewing and signing by the parties with a digital pen or other medium, and verify fields. After a document has been escrowed the document may be selected to finalize 240. The document may be displayed and executed and/or changed 245. The fields on the document may be verified 250, such as checking for an ink change within the field. If the fields do not verify 250, the errors may be displayed 260. The user then may choose to continue anyway 270 or return to the main menu 160. If the user continues anyway or the fields verify, the user may choose to certify the document 280. After the document is certified, the user may choose to release the certified document 290. After release, the user may be returned to the main menu and the certified document may be available for download.

It should be noted that it may be advantageous to require multiple users linked to a document to request a step before the step is performed. For example, it may be advantageous to have two or more users representing each party choose to certify a document before the system performs the certification. Similarly, the two parties may wish to both request the release of the certified document before the document is released. The parties may then be sure that both parties approve of the document in its current state and the document may then be released and certified.

In the case where there is no escrow used, the Document Finalization process may simply verify fields, if chosen, and prevent further alterations to the document. The system may also pre-process the protections and authenticity processing described in the Download Document phase.

The Download Document process may take a finalized document and provide it for download to the parties in a certifiable format. After certification 280 and release 290, a user may select to download a certified document 295. The certified document may contain technology to protect the document and/or to show authenticity. The document protection may include such technology as password protection, document lifecycle administration, encryption, preventions (such as prevention of printing, screenshots or commenting) and other document protection. The authenticity technology may include digital signatures, public key signing, metadata including signing information (such as pen serial number, dates, times, location, people, personal identification, servers, services) and other identification, verification, or authenticity technology.

Turning now to FIG. 5, a preparation process with local software in a digital and remote document revision and execution system with document escrow is shown. In this example, the process may include more local software to offload the work from the server.

After a user signs up for the service 650, the user receives a digital pen (or device) 660 and software 670. The software may be activated to associate a pen and software with an account. Once the software is installed and connecting with the server, a user may choose a document previously created 680 and save it to a PDF 690. The user may import the PDF into an interactive editor that adds the digital pen pattern to the background and allows the user to place fields within the document 700. Once the fields have been created 705, the user may perform a digital printout 710, upload the document to the server 720 and escrow the document 730. In some cases, these steps may be seamless to the user once the user clicks “print”. At the same time, the user may also save a local copy 740 which may include a digital pen pattern. If desired, the user may place DRM or other restricting features on the local copy 750, such that the copy may only be printed a specified number of times. The user may then distribute the local copy to the parties for execution 755.

Turning now to FIG. 6, a flowchart of an execution process with local software in a digital and remote document revision and execution system with document escrow is shown. Local software is installed 760 and a physical print of the document is prepared 770. The user may log into the document viewer 780 which may display the document in the document viewer 790. As ink changes are made 800, they are displayed in the document viewer 790. As an option, the fields may be monitored in real-time or near real-time to make sure each one is filled out 810. After the ink changes 800 are complete, the document may be verified 820 such that each field is accounted for. Once verified 820, the document may be released from escrow 830 and distributed to the parties 840.

Turning now to FIG. 7, a user process flow diagram of a digital and remote document revision and execution system with document escrow is shown. The processes may be divided up into four stages: Document Creation 300, Document Escrow 310, Document Finalization 320 and Document Download 330. An initial setup before the document processes begin may include signing up for an account 340, receiving a digital pen 350 and downloading the software 360.

In the document creation phase 300, a user may prepare the document to become a master document. The document may be created 370 by a user's software, such as a word processor. The document may then be converted to a PDF 380 or other format, such as by printing to a virtual PDF printer. The user may then upload the document 390 to the document server. The user may then add fields to receive ink changes to the document on the server 400 or may designate the document to record ink changes anywhere on the document.

In the document escrow phase 310, a master document may be created and receive ink changes. After desired fields have been added to a document, the user may then choose the document to create a printout 410. The user may distribute the printout document to appropriate parties 420, after which the document may be escrowed 430. The parties may then login to the document viewer to monitor ink changes 440, if desired. The parties may add ink changes to the document through the use of digital pens or other signing technology 450.

The escrow may be a hard or soft escrow. In a hard escrow, once any ink changes have been made on the document, the document cannot be printed or saved without formal release from all of the parties or by a mediator, etc., who has authorization to release the document. In a soft escrow, the document may still be printed or saved, but this is done in a manner which makes it clear that the document is not a final document. Thus, a person who spills coffee on a printed version of a partially executed document could reprint the document for signing. However, the document may bear a mark—such as NON-FINAL or DRAFT—to make clear that it is not the final document released from escrow.

In the document finalization phase 320, the parties and system may review and approve of the document. After the parties have finished execution and/or adding changes to the document, the parties and system may review the document 460. The parties may perform a manual scan of the document to make sure the document is correct and correctly signed. The system may verify that each field has the ink changes expected. Once the parties have reviewed, the parties may then certify the document 470. After certification, the parties may then release the document for download by the parties 480.

In some cases, it may be desirable to further configure the fields. In one embodiment, a user may assign a field to a specific party. The system may correlate a digital pen or device with a party and verify that the party's pen or device has placed an ink change within the field.

In some cases, there may be a desired delay inserted into the process. For example, in one embodiment, the parties may only allow the release of the document after 7 days after certification. During that period, certification may be revoked. In other cases, the delay may work more as a default, such that if a party does not revoke certification after 5 days, the document would automatically be released.

In the document download phase 330, the document may be downloaded by the parties, and if active document management or archival is employed, a document certification server may certify documents as true and correct copies. After release, the parties may download a certified copy of the document 490. The server may provide mechanisms for the parties to recognize certified copies 500, such as keys, certificates or services. If document archival is enabled, the system may also archive the documents for later use.

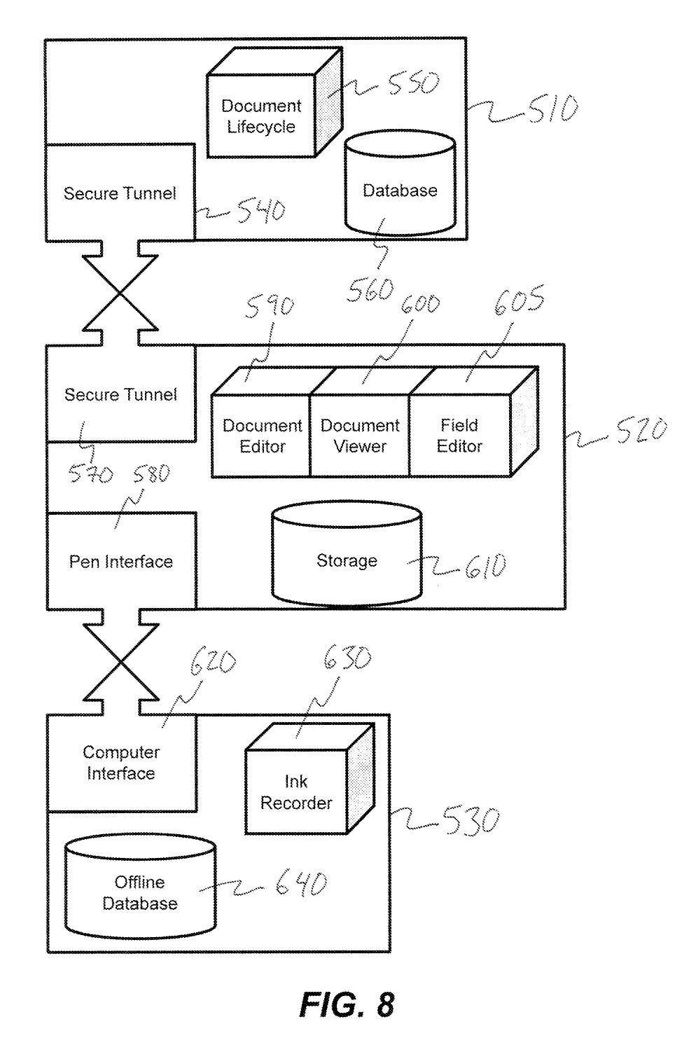

Turning now to FIG. 8, a software interaction diagram of a server 510, client 520 and device 530 in a digital and remote document revision and execution system with document escrow is shown. The server 510 may connect to the client 520 and the client may connect to the device 530. Modules within each computer, such as engines, interfaces and storage may be embodied as a program on a signal bearing medium, which may be processed on a computer.

The server 510 may contain a communications interface 540 with security, document lifecycle engine 550 and storage 560. The communications interface 540 may connect to external services or clients. Here, the communication interface 540 is connected to a client. The communications interface may also connect to external services, such as email, administrative interfaces or credit card processing. The lifecycle engine 550 may include logic and instructions to process documents, including the processes shown in FIGS. 4 to 7. Storage 560, may include databases, disk drives, memory, media and other storage devices to provide data to the lifecycle engine and/or the communications interface 540. This may include user account information, documents, fields, and other information to aid in the processing of documents and system administration.

The client may contain a server interface 570, device interface 580, document editor engine 590, document viewer engine 600, field editor 605 and storage 610. The server interface may allow information to be exchanged with a server 510. The information may include uploading documents, creating fields, receiving master documents to display and other information related to accomplishing tasks and processes described in FIGS. 1 to 7. The device interface 580 may allow the client to relay device information to the server 510 or store the information until the server is available. The document editor engine 590 may include modules or software to add information or otherwise modify a document from the server 510. The document viewer engine 600 may allow the client to display documents, including an escrowed document with ink changes. The document viewer engine 600 may include security such that the document may be prevented from further retrieval outside of the viewer 600. The field editor 605 may allow a client to add fields to a document for verification. The storage 610 may include databases, disk drives, memory, media and other storage devices. The storage may provide data to the various interfaces and engines within the client, including storing information to be relayed to the server if the client cannot reach the server.

The device 530 may contain a computer interface 620, ink recorder 630 and offline database 640. The computer interface 620 may be used to relay information from the device to the server. The ink recorder 630 may record ink changes along with metadata including time, serial number, document location and geographic location. The offline database 640 may store ink changes, metadata and other information necessary for the device to function.

In one embodiment, the client and the pen may be collapsed into a single device, such as a tablet computer. Thus one device may contain a server interface 570, document editor engine 590, document viewer engine 600, ink recorder 630 and storage 640.

It should be recognized that in some cases, the pen may connect directly to the server without a client computer, and the client may connect to the server without a pen connecting to the client. In one embodiment, the pen actually connects to a smartphone through Bluetooth, using the smartphone as a relay for its communications with the server. In another embodiment, a mediator connects to the server to review ink changes, but does not have a pen or device to make any ink changes.

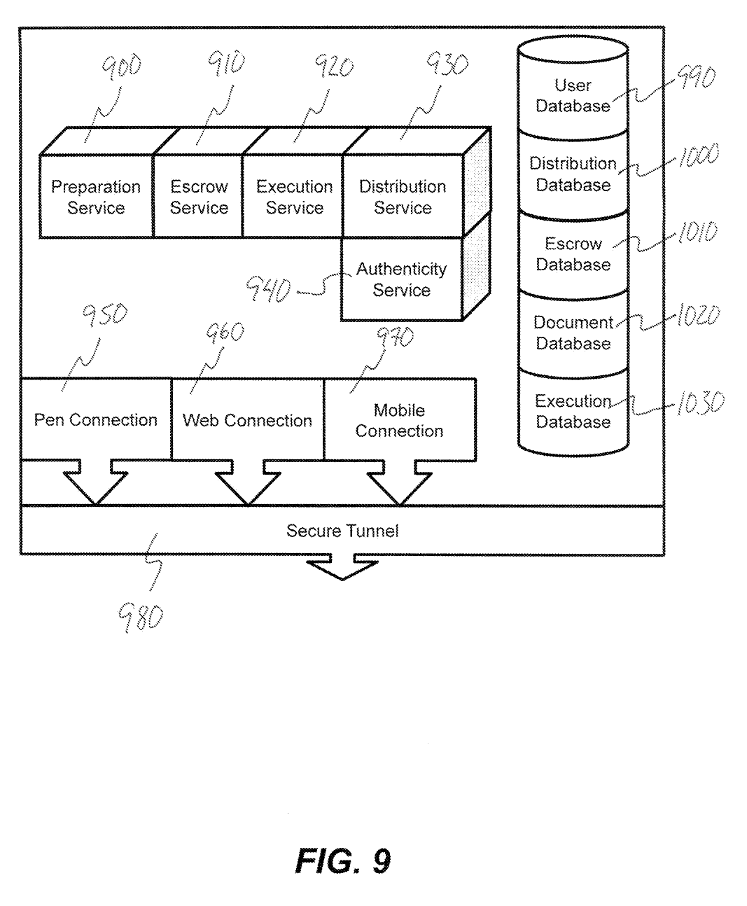

Turning now to FIG. 9, a software configuration of a server in a digital and remote document revision and execution system with document escrow is shown. The server may contain engines, interfaces and storage.

Engines may include a preparation service 900, escrow service 910, execution service 920, distribution service 930, and authenticity service 940. These services may include processes described in FIGS. 4 to 7. The document preparation service 900 may aid in the preparation of the document for escrow, including PDF and field preparation. The escrow service 910 may include the security precautions, DRM or other protections from copying an escrowed document. The execution service 920 may include processes and/or logic to aid in creating, verifying and storing ink changes. The distribution service 930 may aid in the finalizing of a document and distributing a final document after escrow to the parties. The authenticity service 940 may aid in verifying the authentic nature of a document, such as by digital key signatures.

Interfaces may include a pen connection 950, web connection 960, mobile connection 970 and a secure tunnel 980. A pen connection 950 may communicate with pen or device about ink changes and associated data. A web connection 960 may communicate with a computing device, which may include the document viewer, account login and other processes available to a user or administrator. A mobile connection 970 may be tailored to communicate with a mobile device, such as a tablet or smartphone. These interfaces may also be configured to communicate over a secure connection, such as secure tunnel 980.

Storage may include a user database 990, distribution database 1000, escrow database 1010, document database 1020, and execution database 1030. A user database 990 may facilitate user actions and include information about users, accounts and links between users. A distribution database 1000 may facilitate document distribution and include documents, links to authorized users for download and authenticity information. An escrow database 1020 may facilitate document escrow and include documents in escrow, fields and links to authorized parties. An execution database 1030 may facilitate ink changes and include links to authorized users and devices, and store ink changes and fields.

While the diagram shown in FIG. 9 shows various databases, it should be recognized that the storage may be met with alternative means. In one embodiment, there is one database and the information is linked between tables.

While processes and modules have been described with specificity, it should be recognized that portions of the processes or modules may be omitted, changed or relaxed without departing from the spirit of the invention. For example, while a document escrow step has been disclosed, the actual document escrow protections may not be desirable to some parties. The parties may simply wish to verify that the opposing party is signing the document without the formal escrow restrictions Likewise, other simple protections can be provided for restricting use of the document—either by printing notices, or printing controls—until the document has been executed by each party.

There is thus disclosed an improved system for digital and remote document revision and execution with document escrow. It will be appreciated that numerous changes may be made to the present invention without departing from the scope of the claims.

What is claimed is:

1. A server system for escrow of documents, the server comprising:
document storage;
an escrow engine, the escrow engine communicating with document storage to restrict access to one or more escrowed documents upon an escrow request;
an interface to receive ink changes, the ink changes being associated with a first document of the one or more escrowed documents; and
an interface to show ink changes to the first document to one or more users in near real-time.

2. The server system for escrow of documents of claim 1, wherein the escrow engine comprises means for receiving authorization for release of the first document from a plurality of parties.

3. The server system for escrow of documents of claim 1, wherein the server system is disposed in communication with a plurality of digital input devices capable of recording a party's written signature.

4. A process of digitally closing, the process comprising:
receiving a document for closing on a computer network;
displaying the document on displays in communication with the computer network to a plurality of parties to the closing in different locations;
receiving digitized signatures from the plurality of parties as they are signed by the plurality of parties to the document;
certifying the document as complete; and
creating a final digital copy of the executed agreement.

5. The process of claim 4, wherein the process comprises escrowing the document until it has been verified that each party has executed the document.

6. The process of claim 5, wherein the process comprises escrowing the document until each party has verified that the document has been completely executed.

7. The process of claim 4, further comprising the steps of:
adding a set of fields to the document; and
comparing the locations of the signatures to the fields.

8. A signal bearing medium tangibly embodying a program of machine readable instructions executed by a digital processing apparatus to perform an operation to perform a document escrow and receive ink changes, the operation comprising:
receiving a document;
escrowing the document;
digital ink changes to the document;
displaying ink changes on the document; and
removing the document from escrow.

9. A method for executing a document, the method comprising:
loading a document onto a server;
printing a plurality of copies of the document with an optical recognition pattern configured such that a digital pen may be moved over the document and ink markings made on the document are recorded and sent to the server;
having a plurality of parties to the document sign the document with the digital pens; and
displaying the document on a plurality of displays so that any ink markings made are shown on the displays to each of the parties to the agreement.

10. The method according to claim 9, wherein the document is displayed on a plurality of displays in different locations and wherein each ink marking is visible on each display.

11. The method according to claim 9, wherein the method comprises holding the document in escrow until each party has signed the document with the digital pens.

12. A system for the execution of agreements, the system comprising:
at least one document storage medium programmed to hold a digital document;
at least one display remote from the storage medium and in communication with the storage medium for displaying the digital document in near real time; and
a plurality of digital input devices disposed in communication with the at least one document storage medium such that the digital input devices can be manipulated like a pen to make changes to the digital document and to show a graphical representation of a signature of a party to the digital document when the digital input device is moved by the party so as to replicate his or her signature.

13. The system of claim 12, wherein the digital input device comprises a pen such that movement of the pen on a printed copy of the document leaves ink markings on the document.

14. A method for executing a document, the method comprising:
storing a master document on computer medium;
providing a printed copy of the master document to a person for execution, the printed copy having a means for determining location in the document when view by a digital input device;
providing a digital input device and recording a graphical representation of any change made to the printed copy of the master document, including at least signature; and
saving the master document along with any changes made to the printed copy of the master document.
